(19) United States
(12) Patent Application Publication
(10) Pub. No.: US 2006/0146517 A1
(43) Pub. Date: Jul. 6, 2006

(54) Light emitting device for gloves

(75) Inventor: Hyung-gyun Park, Siheung-si (KR)

Correspondence Address: BACON & THOMAS, PLLC, 625 SLATERS LANE, FOURTH FLOOR, ALEXANDRIA, VA, 22314, US

(73) Assignee: DNPKOREA CO., LTD., Siheung-si (KR)

(21) Appl. No.: 11/219,680

(22) Filed: Sep. 7, 2005

(30) Foreign Application Priority Data
Sep. 7, 2004 (KR) 2004-0071353

(51) Int. Cl. F21V 21/08

(52) U.S. Cl. 362/103

(57) ABSTRACT

Disclosed herein is a light emitting device for gloves, which can be detached from the gloves when washing the gloves. The light emitting device comprises a holder fixed to one side of an upper surface of each glove, a lighting member, a device controller electrically connected with the lighting member to turn on or off the lighting member based on the selected on/off control modules after selecting a preprogrmmed on/off control module in response to predetermined switching operations, and a fastening member to attach or detach the device controller to or from the holder. The gloves comprising the light emitting device can be widely used for various operational circumstances and recreations such as fishing, golf, and the like.

### BACKGROUND OF THE INVENTION

1. Field of the Invention The present invention relates to functional gloves, and, more particularly, to a light emitting device for gloves, which comprises a device controller detachably mounted at a predetermined position of each glove, and allows programmable control of turn on/off of the device controller to enhance functionality in operation with the gloves.

2. Description of the Related Art

Generally, functional gloves can be classified into gloves to maintain a person's temperature, and gloves to protect person's hands during recreational activities or in industrial settings. The gloves are made of various materials including fabrics, leather, etc., and have various designs according to application.

Various functional gloves are disclosed in Korean Utility Model Publications, which can enhance utility, stability and wearing sensation. For example, Korean Utility Model Registration No. 20-0348532 discloses gloves entitled “functional gloves.” As shown in FIG. 1, the functional gloves comprise an upper plate 2, and a lower plate 3 which is composed of a double fabric formed by bonding two sheets of net cloths 1 (one of which will be referred to as an upper net cloth, and the other of which will be referred to as a lower net cloth). The fabric constituting the upper and lower plates 2 and 3 has excellent properties in terms of rapid drying and moisture-wicking in order to allow sweat to be quickly wicked away and evaporated. Among the two sheets of the net cloths 1 constituting the bottom plate 3, the upper net cloth 1 comprises honeycomb-shaped holes 4, and a net structure 5 not to hinder the quick drying and moisture-wicking properties of the fabric. A rubber layer 6 is coated on the net structure 5 to increase a gripping force via increase in a frictional force when a user wearing the gloves grips an object.

It is considered that such functional gloves are suitable for recreational activities, such as tennis, golf, and the like, or for industrial settings. In particular, when gripping a handle of a tool while wearing the functional gloves in an industrial setting, a contacting force with the handle is increased by the frictional force caused by the rubber layer 6 deposited on the net structure 5 of the upper net cloth 1 of the bottom plate 3. As such, the bottom plate 3 comprises the upper net cloth 1 composed of the honeycomb-shaped holes 4 and the net structure 5 in addition to the lower net cloth 1, so that the upper net cloth 1 ensures smooth flow of air from and to the gloves, thereby minimizing an obstacle to the quick drying and moisture-wicking properties of the fabric.

However, although the functional gloves of the disclosure are designed to prevent slippage of the tool from the hand only with the shape of the net cloths of the bottom plate, it is difficult in practice to enhance operational efficiency only with slippage preventing function of the gloves, especially, in the industrial settings requiring an operation with various kinds of tools and components. For example, since safety and stability cannot be ensured only with the slippage preventing function of the gloves for an operation in a dark area, there is a significant need in the art to provide functional gloves which can be widely used in various operational circumstances.

### SUMMARY OF THE INVENTION

The present invention has been made to solve the above and other problems, and it is an object of the present invention to provide a light emitting device for gloves, which enables stable operation in a dark area, thereby enhancing work efficiency.

It is another object of the present invention to provide a light emitting device for gloves, which is embodied by a high brightness light emitting diode to provide light emitting function to the gloves, thereby minimizing power consumption.

It is yet another object of the present invention to provide a light emitting device for gloves, which is detachable from the gloves, allowing the gloves to be cleaned in a state in which the light emitting device is detached therefrom.

In accordance with one aspect of the present invention, the above and other objects can be accomplished by the provision of a light emitting device for gloves, comprising: a holder securely fixed to one side of an upper surface of each glove; a lighting member to emit light of a predetermined brightness; a device controller electrically connected with the lighting member to select preprogrammed on/off control modules in response to predetermined switching operations, and to turn on or off the lighting member based on the selected on/off control modules; and a fastening member to attach or detach the device controller to or from the holder.

Preferably, the fastening member comprises mounting pieces formed at both sides of a front side of the device controller, and guide grooves formed at both sides of a front side of the holder such that the mounting pieces are inserted and fastened to the guide grooves, respectively.

Preferably, the holder is positioned on a portion of the upper surface of each glove corresponding to a portion between a thumb and an index finger on the back of a hand.

Preferably, the device controller comprises a main body to operate the on/off control modules in response to on/off controls of the device controller, and a power unit inserted into the main body to allow replacement of a battery and to supply power to the main body.

Preferably, the main body comprises a controller housing of a predetermined shape to mount the lighting member at a front side of the controller housing, at least one switch positioned at one side of the controller housing, and a control unit to perform the on/off controls based on switching signals of the switch.

### BRIEF DESCRIPTION OF THE DRAWINGS

The foregoing and other objects and features of the present invention will be more clearly understood from the following detailed description taken in conjunction with the accompanying drawings, in which:

FIG. 1 is a view illustrating a conventional functional glove;

FIG. 2 is a view illustrating light emitting devices according to the present invention, in which the light emitting devices are attached to gloves;

FIG. 3 is a view illustrating one embodiment of a device controller of the light emitting device;

FIG. 4 is an exploded perspective view of the device controller;

FIGS. 5, 6a and 6b are views illustrating fastening members of the light emitting device;

FIG. 7 is a view illustrating another embodiment of the device controller of the light emitting device; and

FIG. 8 is a view illustrating the device controller of FIG. 7 attached to the gloves.

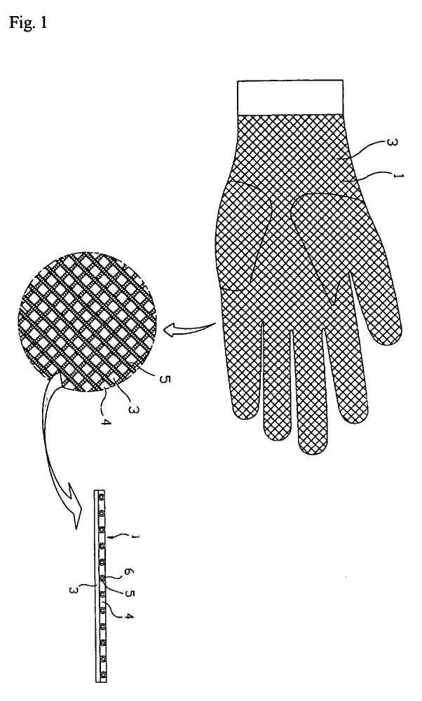

### DESCRIPTION OF THE PREFERRED EMBODIMENTS

Preferred embodiments of the present invention will be described in detail with reference to the accompanying drawings.

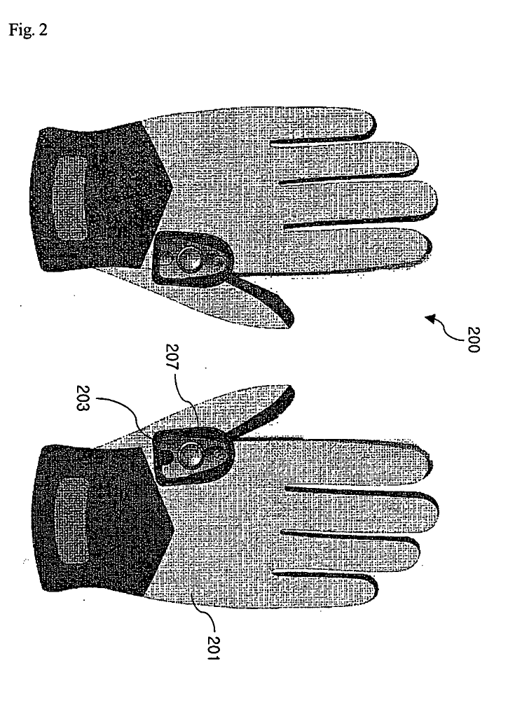

FIG. 2 is a view illustrating light emitting devices according to the present invention, in which the light emitting devices are attached to gloves 200. Each light emitting device comprises a holder 207 attached to an upper surface 201 of each glove 200, and a device controller 203 positioned on the holder 207 to control brightness of light via a switching operation. The holder 207 is a coupling member to attach or detach the device controller 203 to the glove, and is fixed at a predetermined position of each glove 200. The holder 207 is made of flexible fibers or a plastic material, if necessary, and is bonded or sewed to the predetermined position of the glove 200. More specifically, the holders 207 are attached to the upper surfaces 201 of the gloves 200 to allow the device controller 203 to be attached to or detached from the gloves via the holders 207, thereby enhancing operational efficiency by means of the device controller 203. Thus, it is preferable that the holder 207 be positioned on a portion of the upper surface of each glove corresponding to a portion between a thumb and an index finger on the back of the hand. The device controller 203 comprises a battery of a predetermined size, such as a nickel battery, a mercury battery, a lithium battery, an alkaline battery, etc. In this regard, the device controller 203 may have a battery-mounting structure which allows replacement of the battery or a cover-mounting structure which receives the battery therein.

An operation of the device controller 203 will be described as follows.

When performing a task in an industrial setting with hands, on one of which the glove with the device controller 203 attached thereto is worn, if it is necessary to perform the task in a dark area, turning-on/off of the device controller 203 is controlled by the other hand. The device controller 203 actuates preprogrammed on/off control modules in response to the on/off controls of the user to turn-on or turn-off a lighting member (which is not indicated by a reference numeral) mounted in the device controller 203. The on/off control modules allow the device controller 203 to be maintained in a continuous turn-on state or in a temporary turn-on state for a predetermined period of time, for example, for 5 to 9 minutes, or to be repetitiously turned on and off for a predetermined period of time in accordance with switching operations of the device controller 203. The on/off controls described above can be set by the user according to conditions of an operation, such as continuous operation in the dark area or temporary operation in the dark area.

When washing the gloves 200 after using the device controller 203, the gloves 200 with the holders 207 attached thereto can be washed after detaching the device controller 203 from the holder 207. Since the holder 207 is formed from the fabric, and has a structure to which the device controller 203 can be detachably mounted, it is possible to separate the device controller 203 from the holder 207 when washing the glove 200 and the holder 207 made of the fabric, and to attach the device controller 203 to the holder 207 when using the glove 200 again.

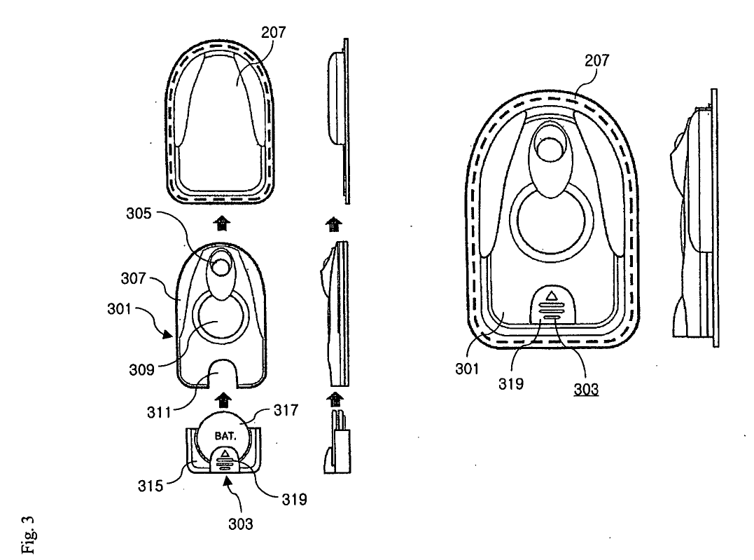

FIG. 3 illustrates main components of the present invention. In FIG. 3, the device controller 203 comprises a main body 301, and a power unit 303 fastened to the main body 301. The main body 301 is mounted on the holder 207 via a fastening member. The main body 301 comprises a controller housing 307 of a predetermined shape, a lighting member 305 positioned at a front side of the controller housing 307 to emit light of a predetermined brightness, and a switch 309 positioned at one side of the controller housing 307. The controller housing 307 comprises an upper fastening groove 311 formed at one side thereof to allow the power unit 303 to be inserted and fastened to the upper fastening groove 311.

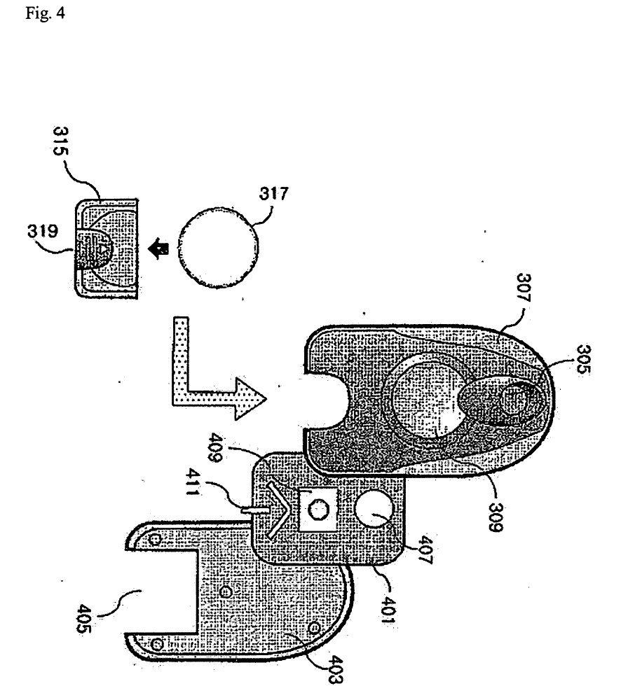

The power unit 303 comprises a battery housing 315 to receive a battery 317, and an attachment handle 319 formed on an upper side of the battery housing 315. The power unit 303 is coupled to the controller housing 307 by inserting and fastening the attachment handle 319 to the upper fastening groove 311. At this time, the battery housing 315 of the power unit 303 is inserted and fastened to a lower fastening groove (see FIG. 4) formed on a lower surface of the controller housing 307. Thus, the power unit 303 allows the battery 317 to be received in the controller housing 307 through the upper fastening groove 311 and the lower fastening groove 311 while preventing the power unit 303 from being detached from the controller housing 307.

FIG. 4 is an exploded perspective view of the device controller 203.

The device controller 203 is provided with a lower cover 403 facing the controller housing 307 to define a predetermined space therebetween. The lower cover 403 comprises the lower fastening groove 405 to which the battery housing 315 of the power unit 303 is slid and fastened. A PCB 401 is embedded between the controller housing 307 and the lower cover 403, and is supplied with power from the power unit 303 to perform the on/off controls on the basis of switching signals of the switch 309.

The PCB 401 comprises a microcomputer 407 having programmed on/off control modules, a switching element 409 to perform electrical contact according to the switching operation of the switch 309, and a power connection terminal 411 to receive power from the battery of the power unit 303.

After the PCB 401 is mounted into the controller housing 307, the lower cover 403 is coupled to the lower surface of the controller housing 307. Then, the power unit 303 with the battery 317 mounted therein is slid into the main body 301 of the device controller. At this time, the attachment handle 319 of the power unit 303 is fastened to the upper fastening groove 311 of the controller housing 307, and then the battery housing 315 of the power unit 303 is fastened to the lower fastening groove 405 of the lower cover 403.

As a result, the battery 317 is electrically connected to the power connection terminal 411 of the PCB 401, so that the microcomputer 407 is supplied with the power from the battery 317. In addition, the microcomputer 407 is connected to the lighting member 305 to control turn-on/off of the lighting member 305. Here, the lighting member 305 may comprise a light emitting diode or a high brightness light emitting diode. In addition, as for the switching element 409, a plate switch or a membrane switch can be used. The switch 309 for operating the switching element 409 is formed of silicone or rubber materials, and has a predetermined resilience. Meanwhile, the microcomputer 407 comprises a first turn-on control module to allow continuous turn-on of the lighting member 305, a second turn-on control module to allow flash of the lighting member 305 for a predetermined period of time, a third turn-on control module to turn-off the lighting member 305 after turning on the lighting member 305 for a predetermined period of time, a fourth turn-on control module to allow control of brightness of the lighting member 305 through control of current applied to the lighting member, and a turn-off control module to turn off the lighting member 305, according to switching signals inputted through the switching element 409. The switching signals to operate the first to fourth turn-on control modules and the turn-off control module can be defined by a series of sequences or by input times of the switching signals. It is preferable that a period of turning on the lighting member 305 is about 7 minutes in the third turn-on control module. The control of the brightness of the lighting member 305 by the fourth turn-on module can be performed by controlling current applied to the lighting member 305.

If the switching signals are defined by the series of sequences to separately operate the respective modules, the microcomputer 407 responds to the sequence of the switching signals and sequentially operates the respective on/off control modules according to the sequence of the switching signals. On the other hand, if the switching signals are defined by the input times of the switching signals to separately operate the respective modules, the microcomputer 407 sequentially operates the respective on/off control modules according to times of generating the switching signals, i.e., periods of time (programmed set times) of pushing the switching element 409 by the switch 309.

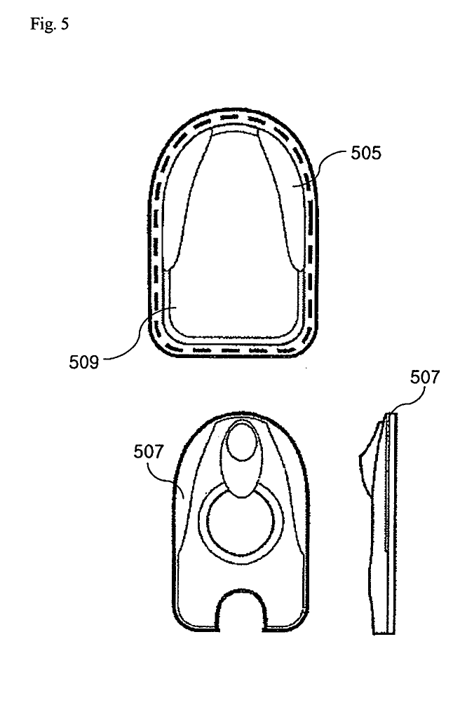

FIG. 5 illustrates one embodiment of a fastening member of the light emitting device.

As shown in FIG. 5, the main body 301 (FIG. 3) comprises mounting pieces 507 formed at both sides of a front side thereof, and the holder 207 (FIG. 3) comprises a base 509 of a predetermined shape, and guide grooves 505 formed at both sides of a front surface of the base 509. Each of the guide grooves 505 has a predetermined width, and is formed along an outer periphery of the base 507 such that the mounting pieces 507 of the main body 301 (FIG. 3) are fastened to the guide grooves 505, respectively. In addition, the shapes of the guide grooves 505 correspond to those of the mounting pieces 507, so that the main body 301 is stably mounted to the holder 207 without being detached from the holder 207 and impeding the light emitted from the lighting member 305.

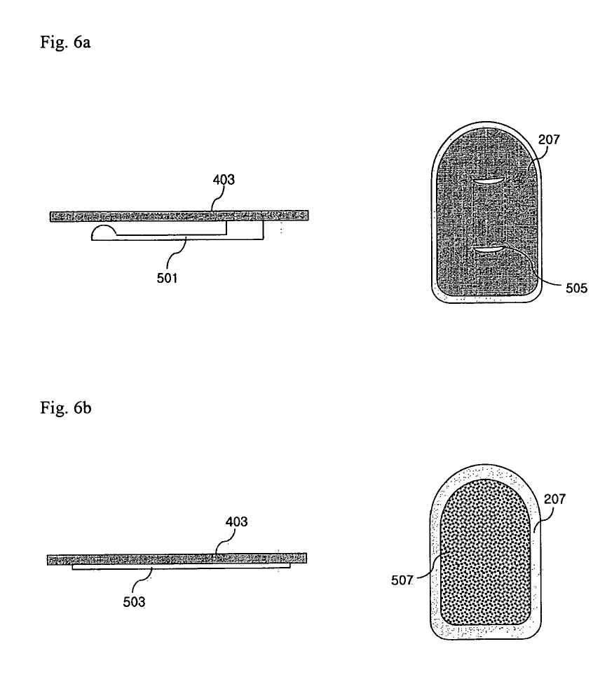

FIGS. 6a and 6b illustrate other embodiments of the fastening member.

As shown in FIG. 6a, the fastening member can be embodied by a fastening pin 501 mounted to a lower surface of the lower cover 403 of the main body 301 (FIG. 3) to impart a predetermined resilience perpendicular to the main body 301. In addition, the holder 207 is formed with a throughway 505 to allow the fastening pin 501 to be inserted a predetermined depth therein, so that the main body 301 is fixed to the holder 207 by inserting the fastening pin 501 to the throughway 505. Thus, when attaching the main body 301 of the device controller to the holder 207 mounted on the upper surface of each glove 200, the fastening pin 501 provided to the lower surface of the main body 301 is inserted to the throughway 505 of the holder 207, so that an operation can be efficiently performed in a dark area by using the gloves 200. Although the gloves for operation in various industrial settings are illustrated in the present embodiment, it should be noted that the gloves of the invention can be used for various recreational activities, such as fishing, golf, etc.

As shown in FIG. 6b, the fastening member can be embodied by a metallic member 503 attached to a lower surface of the lower cover 403 of the main body 301 (FIG. 3) and a magnetic member 507 mounted on the holder 207 to provide a predetermined magnetic force. Here, the magnetic member 507 is preferably a rubber magnet, which is divided into particles of a predetermined size so as to permit smooth flow of the particles when using the gloves 200. Thus, when attaching the main body 301 of the device controller to the holder 207 mounted on the upper surface of each glove 200, the metallic member 503 of the main body 301 is attached to the holder 207 by the magnetic member 507 of the holder 207.

With this construction as described above, if the user wishes to turn on the lighting member 305 in the device controller 203 during an operation with the gloves 200 having the holders 207 mounted thereon, the device controller 203 can be used after the metallic member 503 attached to the lower surface of the lower cover 403 of the main body 301 is fixed to the holder 207 by the magnetic member 507 of the holder 207, so the operation can be performed in the dark area.

Meanwhile, according to still another embodiment of the fastening member, the fastening member can be embodied by a snap member. The snap member is constructed of snap buttons, and provided between the holder 207 of each glove and the main body 301 of the device controller, thereby enabling the main body 301 to be freely attached to or detached from the holder 207 and to be rotated thereon. In addition, according to other embodiments of the fastening member, the fastening member can be embodied by a dot button comprising an irregular shaped metal button or by a Velcro fastener, if necessary. The Velcro fastener is constructed of synthetic wool pieces formed by bonding female and male pieces to the holder 207 and the main body 301, respectively, and provides advantages of remarkable reduction in manufacturing costs and easy cleaning of the gloves.

According to the present invention, the lighting member 305 may comprises a plurality of lighting elements in order to increase brightness of the lighting member 305. In this regard, the number of switches 309 can be determined according to the number of on/off control modules of the microcomputer 407. Thus, when the lighting member 305 comprises the plural lighting elements, the lighting member 305 is turned on to allow light emitted from the plural light emitting elements to overlap according to the switching signals of the switching element 409, and a plurality of switches 309 are provided, if necessary, to separately control the plurality of on/off control modules.

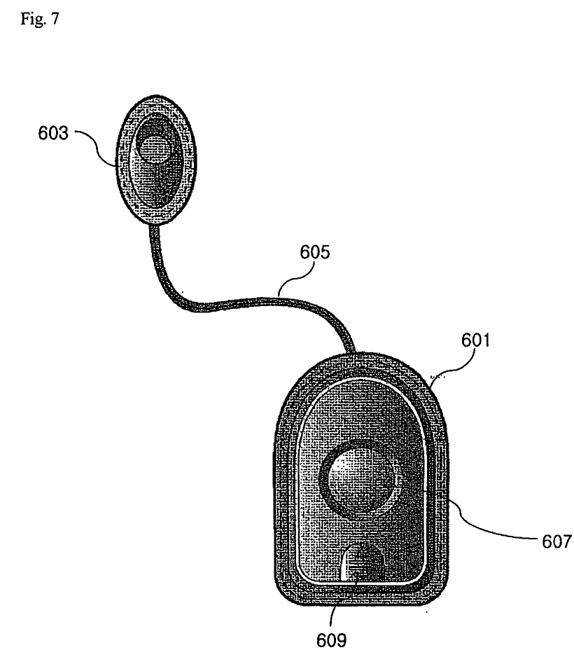

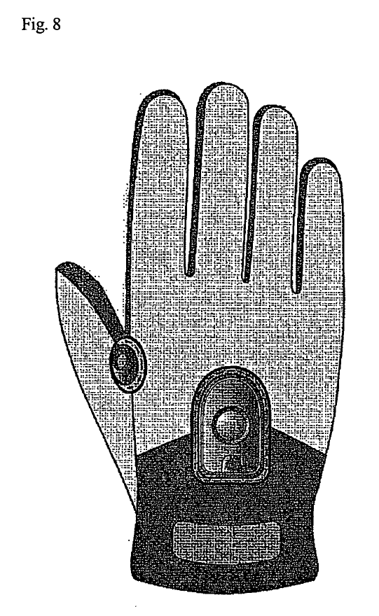

According to the present embodiment, the main body 301 of the device controller comprises the controller housing 307 and the lighting member 305 as an integral component. However, it should be noted that the controller housing 307 and the lighting member 305 can be provided as separate components to enhance user convenience. Thus, as shown in FIG. 7, the device controller comprises a controller housing 601 of a predetermined shape, a switch 607 provided at one side of the controller housing 601 to switch power on or off, a power unit 609 coupled to the controller housing 601 to supply power, a connection line 605 to supply the power of the power unit 609 in response to power control of the switch 607, and a lighting member 603 connected to a distal end of the connection line 607 to emit light. As described above, the controller housing 601 is detachably attached to each glove via the holder, and the lighting member 603 is also detachably attached to the holder of a predetermined shape such that the lighting member 603 is attached to or detached from a specified position of the glove. Alternatively, the lighting member 603 may comprise a Velcro fastener provided to a lower surface thereof such that it can be attached to or detached from a non-specified position of the glove. In this embodiment, as shown in FIG. 7, the holder is sewed to each glove such that the housing 601 is mounted on the upper surface of the glove, and the lighting member 603 is attached to or detached from the non-specified position of the glove.

It should be understood that the embodiments and the accompanying drawings have been described for illustrative purposes and the present invention is limited by the following claims. Further, those skilled in the art will appreciate that various modifications, additions and substitutions are allowed without departing from the scope and spirit of the invention as set forth in the accompanying claims.

What is claimed is:

1. A light emitting device for gloves, comprising:
a holder securely fixed to one side of an upper surface of each glove;
a lighting member to emit light of a predetermined brightness;
a device controller electrically connected with the lighting member to select preprogrammed on/off control modules in response to predetermined switching operations, and to turn on or off the lighting member based on the selected on/off control modules; and
a fastening member to attach or detach the device controller to or from the holder.

2. The light emitting device according to claim 1, wherein the fastening member comprises mounting pieces formed at both sides of a front side of the device controller, and guide grooves formed at both sides of a front side of the holder such that the mounting pieces are inserted and fastened to the guide grooves, respectively.

3. The light emitting device according to claim 1, wherein the fastening member comprises a fastening pin mounted to a lower surface of the device controller, and a throughway formed in a front surface of the holder to allow the fastening pin to pass through the throughway.

4. The light emitting device according to claim 1, wherein the fastening member is a Velcro fastener attached between a lower surface of the device controller and the holder.

5. The light emitting device according to claim 1, wherein the holder is positioned on a portion of the upper surface of each glove corresponding to a portion between a thumb and an index finger on the back of a hand.

6. The light emitting device according to claim 1, wherein the device controller comprises a main body to operate the on/off control modules in response to on/off controls of the device controller, and a power unit inserted to the main body to allow replacement of a battery and to supply power to the main body.

7. The light emitting device according to claim 6, wherein the battery is one selected from a nickel battery, a mercury battery, a lithium battery, and an alkaline battery, each having a predetermined size.

8. The light emitting device according to claim 6, wherein the main body comprises a controller housing of a predetermined shape, a connection line extending from the controller housing and being connected to the lighting member to transmit power from the power unit to the lighting member, at least one switch positioned at one side of the controller housing, and a control unit to perform the on/off controls based on switching signals of the switch.

9. The light emitting device according to claim 6, wherein the main body comprises a controller housing of a predetermined shape to mount the lighting member at a front side of the controller housing, at least one switch positioned at one side of the controller housing, and a control unit to perform the on/off controls based on switching signals of the switch.

10. The light emitting device according to claim 8, wherein the main body comprises an upper fastening groove formed at one side of the controller housing to allow the power unit to be inserted and fastened to the upper fastening groove, and a lower fastening groove formed at one side of a lower surface of the controller housing to allow the power unit to be inserted and fastened to the lower fastening groove.

11. The light emitting device according to claim 9, wherein the main body comprises an upper fastening groove formed at one side of the controller housing to allow the power unit to be inserted and fastened to the upper fastening groove, and a lower fastening groove formed at one side of a lower surface of the controller housing to allow the power unit to be inserted and fastened to the lower fastening groove.

12. The light emitting device according to claim 1, wherein the lighting member comprises a high brightness light emitting diode.

13. The light emitting device according to claim 1, wherein the lighting member comprises at least two lighting elements.

14. The light emitting device according to claim 8, wherein the at least one switch is a plurality of switches corresponding to the on/off control modules.

15. The light emitting device according to claim 9, wherein the at least one switch is a plurality of switches corresponding to the on/off control modules.

16. The light emitting device according to claim 8, wherein the control modules comprise a first turn-on control module to allow continuous turn-on of the lighting member, a second turn-on control module to allow flash of the lighting member for a predetermined period of time, a third turn-on control module to turn-off the lighting member after turning on the lighting member for a predetermined period of time, a fourth turn-on control module to allow control of brightness of the lighting member through control of current applied to the lighting member, and a turn-off control module to turn-off the lighting member, according to the switching signals.

17. The light emitting device according to claim 9, wherein the control modules comprise a first turn-on control module to allow continuous turn-on of the lighting member, a second turn-on control module to allow flash of the lighting member for a predetermined period of time, a third turn-on control module to turn-off the lighting member after turning on the lighting member for a predetermined period of time, a fourth turn-on control module to allow control of brightness of the lighting member through control of current applied to the lighting member, and a turn-off control module to turn-off the lighting member, according to the switching signals.

18. The light emitting device according to claim 16, wherein the switching signals to operate the first to fourth turn-on control modules and the turn-off control module are defined by a series of sequences or by input times of the switching signals.

19. The light emitting device according to claim 19, wherein the switching signals to operate the first to fourth turn-on control modules and the turn-off control module are defined by a series of sequences or by input times of the switching signals.
